(19) United States
(12) Patent Application Publication
(10) Pub. No.: US 2010/0051704 A1
(43) Pub. Date: Mar. 4, 2010

(54) SYSTEMS AND METHODS FOR IMPLEMENTING A PRESENTATION INSTRUMENT BOOKMARK

(75) Inventors: Keith Newbrough, Parker, CO (US); Peter Robbins, Centennial, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 12/203,569

(22) Filed: Sep. 3, 2008

(51) Int. Cl. G06K 19/00

(52) U.S. Cl. 235/493; 235/487

(57) ABSTRACT

The invention provides various systems and methods for implementing a presentation instrument bookmark. The presentation instrument may include a first panel. The first panel may include an account identifying device configured to identify an account associated with the presentation instrument. The presentation instrument may also include a second panel sandwiched with the first panel. The second panel may include a thumb hole cutout configured to allow the presentation instrument to be used as a bookmark.

### FIELD OF THE INVENTION

The present invention relates, in general, to presentation instruments, and more particularly, to presentation instruments configured as a bookmark device.

### BACKGROUND OF THE INVENTION

Presently, customers may have stored value, loyalty and other various cards for use with merchants. Such cards typically are placed in the customer's purse or wallet and only taken out when the customer desires to access the funds or loyalty program rewards, which limits the card's effective value to the customer because most of the time the card is placed in a purse or wallet. Hence, it would be beneficial to a customer to have the stored value or loyalty card have a dual purpose to increase its usefulness. Accordingly, improvements in the art are needed.

### BRIEF SUMMARY OF THE INVENTION

The present invention provides a presentation instrument. The presentation instrument may include a first panel. The first panel may include an account identifying device configured to identify an account associated with the presentation instrument. The presentation instrument may also include a second panel sandwiched with the first panel. The second panel may include a thumb hole cutout configured to allow the presentation instrument to be used as a bookmark.

An alternative embodiment provides a method of implementing a bookmark presentation instrument. The method may include providing a presentation instrument that has an associated value. The method may further include associating an identifier with the presentation instrument that is configured to identify the associated value, and attaching an account identifying device to the presentation instrument configured to allow access to the associated value. Further, the method may include attaching a clip member to the presentation instrument that is configured to allow the presentation instrument to be used as a bookmark. The method may then place the presentation instrument in a book to hold a place in the book, and access the associated value from the presentation instrument via the account identifying device.

A further embodiment of the present invention provides a machine-readable medium for implementing a bookmark presentation instrument. The machine-readable medium may include instructions for providing a presentation instrument that has an associated value. The machine-readable medium may further include instructions for associating an identifier with the presentation instrument that is configured to identify the associated value and instructions for attaching an account identifying device to the presentation instrument configured to allow access to the associated value. Further, the machine-readable medium may include instructions for attaching a clip member to the presentation instrument that is configured to allow the presentation instrument to be used as a bookmark. The machine-readable medium may then include instructions for placing the presentation instrument in a book to hold a place in the book and instructions for accessing the associated value from the presentation instrument via the account identifying device.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIGS. 1A and 1B are block diagrams illustrating a presentation instrument, according to one embodiment of the present invention.

FIG. 2 is a flow diagram illustrating using a presentation instrument as a bookmark, according to one embodiment of the present invention.

FIG. 3 is a block diagram illustrating a system for accessing value associated with a presentation instrument, according to one embodiment of the present invention.

FIG. 4 is a generalized schematic diagram illustrating a computer system, in accordance with various embodiments of the invention.

FIG. 5 is a block diagram illustrating a networked system of computers, which can be used in accordance with various embodiments of the invention.

### DETAILED DESCRIPTION OF THE INVENTION

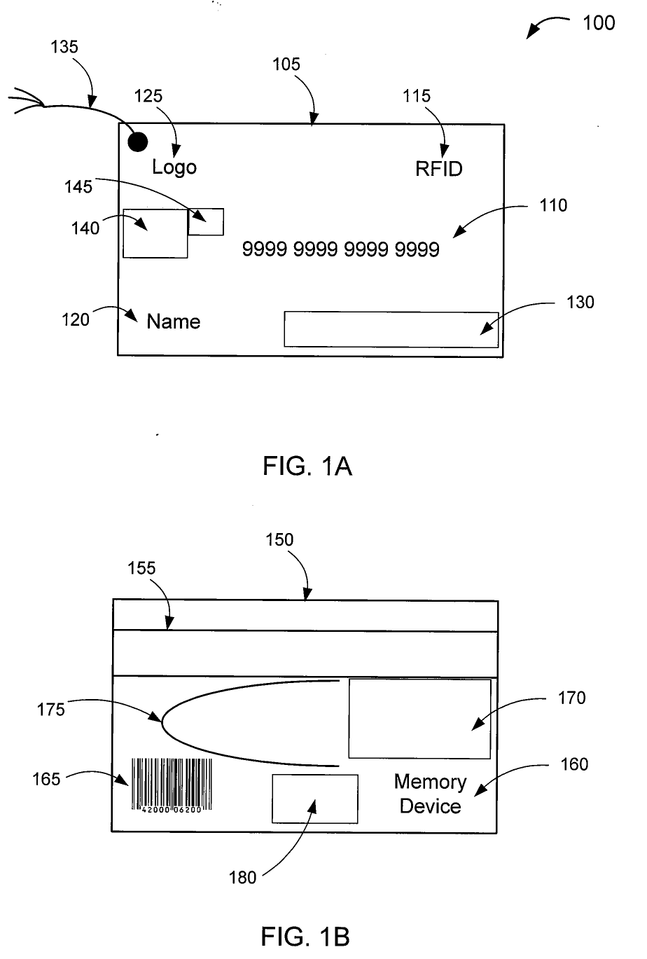

Turning now to FIG. 1A, which illustrates a presentation instrument 100 according to one embodiment of the present invention. Presentation instrument 100 may include a first panel 105 (i.e., a front side) which may include an account number 110, a name 120, and/or a logo 125. In one embodiment, account number 110 may be a unique identifier for a consumer's value account associated with presentation instrument 100. For example, the value account may be a stored value account, a debit account, a credit account, a loyalty program account, a gift card, a prepaid credit card account, etc. Name 120 may be the consumer's name, and logo 125 may be a logo for the entity which is servicing the value account and/or a merchant associated with the value account. For example, assuming that a bookstore chain merchant is associated with the value account, then the bookstore chain's (although other merchants and merchant types may be used) logo and/or name would be placed on presentation instrument 100. Alternatively, the logo and/or name may be placed as the background of presentation instrument 100 partially or completely filling the face of first panel 105.

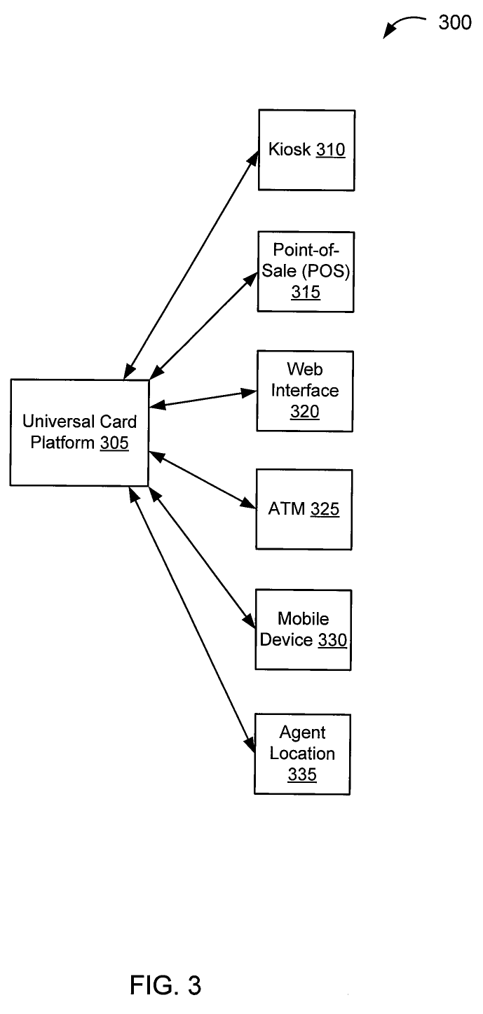

In a further embodiment, presentation instrument 100 may include a RFID 115. RFID 115 may be configured to transmit information to, for example, Kiosk 310 (FIG. 3), POS 315 (FIG. 3), or ATM 325 (FIG. 3). Furthermore, RFID 115 may transmit/receive value account information associated with presentation instrument 100 to and from the entity servicing the value account. It should be noted that transmissions, data packet(s) and/or the transmission mediums used for transmission may be secured by appropriate means (e.g., encryption).

In yet another embodiment, presentation instrument 100 may include a writing device 130 attached to first panel 105. Writing device 130 may be a pen, a pencil, a colored pencil, a highlighter, a felt-tipped pen, a stylus, etc. Furthermore, writing device 130 may be embedded into presentation instrument 100 such that writing device 130 may be “clicked-in” a receptacle (not shown) which is configured to hold writing device 130 in the receptacle and when in use writing device 130 may be “popped out” of the receptacle. Alternatively, writing device 130 may be attached to presentation instrument 100 using perforation around the edges of writing device 130. Accordingly, writing device 130 may be removed from presentation instrument 100 by breaking the perforation tabs around writing device 130.

Presentation instrument 100 may further include a tassel 135. In one embodiment, tassel 135 is made from plastic, fabric, or any other suitable material. Tassel 135 may be attached to presentation instrument 100 by a punched out section of presentation instrument 100. Thus, tassel 135 may be tied, laced, stapled, glued, or otherwise attached to presentation instrument 100. Tassel 135 may be used by a consumer to facilitate holding the consumer's place in a book (i.e., as a bookmark). Tassel 135 may protrude out from the place being marked within the book (or other reading material such as a magazine, a newspaper, a journal, a comic book, etc.) in order to alert the consumer of the marked place in the book.

In a further embodiment, presentation instrument 100 may include a lighting device 140 and a power source 145 attached to lighting device 140 in order to provide power. Power source 145 may be a lithium-ion battery, a wafer battery, an alkaline battery, a nickel-iron battery, etc. Lighting device 140 may be an LED light, an incandescent light, a florescent light, etc. Furthermore, lighting device 140 and power source 145 may be removed/replaced to/from presentation instrument 100 similar to the manner in which writing device 130 is removed and replaced within presentation instrument 100. For example, a receptacle (not shown) may be placed in presentation instrument 100 which allows lighting device 140 and power source 145 to be placed in and removed from presentation instrument 100. Furthermore, lighting device 140 may also be configured to be used while still embedded in presentation instrument 100, and may be alternatively permanently attached to presentation instrument 100. Lighting device 140 may be used, for example, by a consumer to read a book or other publication while in a poorly lighted location.

Furthermore, it should be noted that some (or all) of the features in FIG. 1A are drawn to scale or are constructed in their usable shape or size. The figure is merely used for the purpose of reference and explanation. Furthermore, the location and placement of each item within presentation instrument 100 may be moved to a different location. For example, writing device 130 may be moved to the top of first panel 105, and lighting device 140 may be moved to the right side of first panel 105, etc. Also, it should be noted that the dimensions of presentation instrument 100 may be changed to any desirable dimensions, and FIG. 1A should not be construed to restrict the dimensions of presentation instrument 100 in any way.

Turning now to FIG. 1B, which further illustrates presentation instrument 100 according to one embodiment of the present invention. Presentation instrument 100 may include a second panel 150 (i.e., back side). In one embodiment, second panel 150 may include a magnetic stripe 155. Magnetic stripe 155 may include value account information which can be swiped at, for example, a POS 315 (FIG. 3), kiosk 310 (FIG. 3), ATM 325 (FIG. 3), etc. Furthermore, presentation instrument 100 may include a memory device 160, and/or a barcode 165. Memory device 160 may store account and/or other information related to the value account. Memory device 160 may also be configured to store electronic books and other publications which can be downloaded to a computer, PDA, cellular phone, etc. or which can be read using display device 170. Memory device 160 may be a flash device, a secure digital (SD) device, a mini SD device, a micro SD device, etc. Furthermore, memory device 160 may be embedded in presentation instrument 100 or alternatively may be able to be removed and replaced in receptacle (not shown) with electric contact points.

In a further embodiment, presentation instrument 100 may include a barcode 165, which, similar to magnetic stripe 155, may be used to transmit account information to a receiving device. Alternatively, presentation instrument 100 may include electric contact points (not shown) which may be connected with an electronic device to send and receive data to an from presentation instrument 100. Presentation instrument 100 may also include a display 170. Display 170 may be a LED display, organic LED display, a liquid crystal display, etc. Display 170 may be powered by power source 145 (FIG. 1A). As mentioned above, display 170 may be used to display book or other publications stored on memory device 160. Alternatively, display 170 may be used to display value account balance and/or reward information, special offers and coupons, as well as book, video, and other publication release/status information.

In yet a further embodiment, presentation instrument 100 may include a clip member (or thumb hole cutout) 175. Clip member 175 may be attached to the exterior of presentation instrument 100, or may be cut-out from the body of presentation instrument 100. Clip member 175 may be rounded as shown; however, clip member 175 may also have a squared, V-shaped, etc. end. Clip member 175 may be pulled out from presentation instrument 100 and used as a bookmark for holding a consumer's place in a book or other publication. For example, presentation instrument 100 may be placed at one location within the book, and clip member 175 may be placed in another location in order to hold the consumer's place within the book.

Further, presentation instrument 100 may include a magnifying glass 180. Magnifying glass 180 may be constructed from a variety of materials, for example, glass, plastic, etc. Magnifying glass 180 may also be removably attached to presentation instrument 100 or alternatively may be embedded within the body of presentation instrument 100. For example, magnifying glass 180 may be placed in a receptacle (not shown) and may removed/replaced within that receptacle. Alternatively, magnifying glass 180 may provide a transparent magnifying space completely through both first panel 105 and second panel 150 of presentation instrument 100. As such, magnifying glass 180 may be used by holding presentation instrument 100 over the text and/or graphics which the consumer desires to magnify. Accordingly, magnifying glass 180 may be used to facilitate reading of small text/graphics or help consumers who are visually impaired to read text/graphics.

Furthermore, it should be noted that some (or all) of the features in FIG. 1B are drawn to scale or are constructed in their usable shape or size. The figure is merely used for the purpose of reference and explanation. Furthermore, the location and placement of each item within presentation instrument 100 may be moved to a different location. For example, clip member 175 may be moved to the top of second panel 150 (or even placed on first panel 105), and memory device 160 may be moved to the left side of second panel 150, etc. Also, is should be noted that the dimensions of presentation instrument 100 may be changed to any desirable dimensions and FIG. 1B should not be construed to restrict the dimensions of presentation instrument 100 in any way. In a further embodiment, the thickness of first panel 105 and second panel 150 sandwiched together may be 30 mils or less; however, other greater thicknesses may be used.

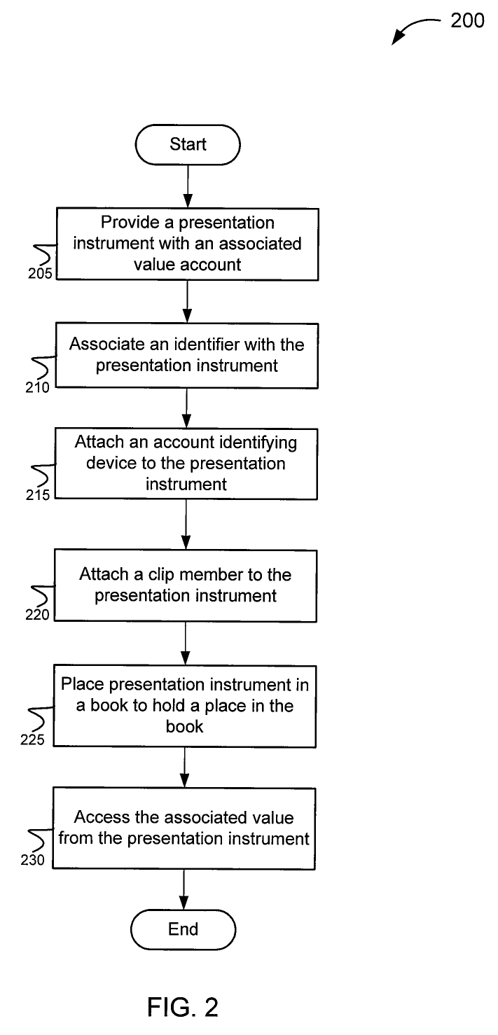

Referring now to FIG. 2, which illustrates a method 200 for using a presentation instrument as a bookmark. At process block 205, a consumer may be provided with a presentation instrument which is associated with a value account. The value account may be, for example, a stored value account, a gift account, a credit account, a loyalty account, a prepaid account, etc. The presentation instrument may be configured to be used as a bookmark. Merely by way of example, assume that the value account associated with the presentation instrument is a bookstore loyalty/reloadable gift card account. The consumer may go into a store location or a website to retrieve the presentation instrument. Upon receipt of the presentation instrument, the presentation instrument may have an identifier associated with the instrument in order to identify the value account associated with the presentation instrument (process block 210).

At process block 215, an account identifying device (e.g., a magnetic stripe, barcode, memory device, RFID, etc.) may be attached to the presentation instrument in order to store account information and associate the presentation instrument with the value account. Furthermore, a clip member 175 (FIG. 1B) may be attached to the presentation instrument in order to allow the instrument to be used as a bookmark (process block 220). The presentation instrument may then be placed in a book or other publication to hold a place within the book for the consumer (process block 225). For example, the consumer may be sitting in a reading area of the bookstore associated with the presentation instrument loyalty/gift card account, and the consumer may desire to purchase a new book. The consumer can simply remove the presentation instrument bookmark from the book they are reading, select the desired book to purchase, and pay for the book with the instrument, while at the same time earning rewards through the rewards program (process block 230). Furthermore, the consumer may be able to access a kiosk (e.g., kiosk 310 (FIG. 3)) and receive bonus rewards, coupons, rebates, etc. which may be redeemed while in the bookstore while using the presentation instrument bookmark. Hence, after the consumer has made their purchase(s) and has left the bookstore, the consumer can place the presentation instrument in the book they are reading in order to mark their place in the book.

Referring next to FIG. 3, which illustrates a system 300 for accessing value associated with a presentation instrument. System 300 may include a universal card platform 305. In one embodiment, universal card platform 305 may be configured to manage the value accounts associated with the presentation instruments. For example, universal card platform 305 may store identifiers and account information for each value account. Universal card platform 305 may be able to access and retrieve, for example, current balance information, reward information, consumer name, address, phone number, and other contact information. Furthermore, universal card platform 305 may be able to authorize funds transfers as well as credit additional funds to the value accounts. As such, universal card platform 305 is configured to manage and administer each of the value accounts associated with the bookmark presentation instrument.

In one embodiment, system 300 may also include various interfacing devices/location. For example, system 300 may include a kiosk 310, a POS 315, a web interface 320, an ATM 325, a mobile device 330, and an agent location 335. Each of these interfacing devices/locations may be configured to interact with the bookmark presentation instrument. These devices/locations may receive information about the value account and transmit such information to universal card platform 305, as well as receive information regarding the value accounts from universal card platform 305.

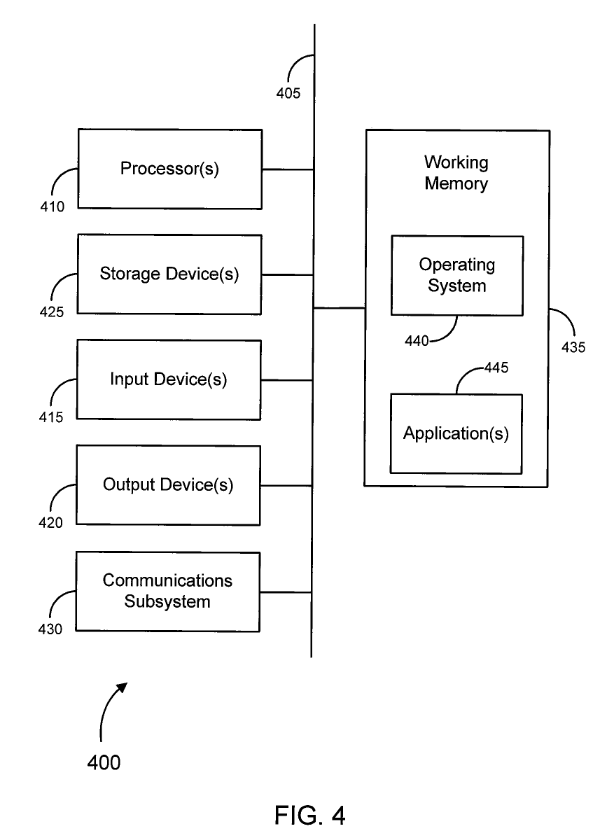

FIG. 4 provides a schematic illustration of one embodiment of a computer system 400 that can perform the methods of the invention, as described herein, and/or can function as, for example, universal card platform 305 (FIG. 3), etc. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements can include one or more processors 410, including, without limitation, one or more general-purpose processors and/or one or more special-purpose processors (such as digital signal processing chips, graphics acceleration chips, and/or the like); one or more input devices 415, which can include, without limitation, a mouse, a numeric keypad, a keyboard, a touch screen, and/or the like; and one or more output devices 420, which can include, without limitation, a display device, a printer, a soundcard and/or the like.

The computer system 400 may further include (and/or be in communication with) one or more storage devices 425, which can comprise, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computer system 400 might also include a communications subsystem 430, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 430 may permit data to be exchanged with a network (such as the network described below, to name one example), and/or any other devices described herein. In many embodiments, the computer system 400 will further comprise a working memory 435, which can include a RAM or ROM device, as described above.

The computer system 400 can also comprise software elements, shown as being currently located within the working memory 435, including an operating system 440 and/or other code, such as one or more application programs 445, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 425 described above. In some cases, the storage medium might be incorporated within a computer system, such as the system 400. In other embodiments, the storage medium might be separate from a computer system (e.g., a removable medium, such as a compact disc, etc.), and or provided in an installation package, such that the storage medium can be used to program a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection with other computing devices such as network input/output devices may be employed.

In one aspect, the invention employs a computer system (such as the computer system 400) to perform methods of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another machine-readable medium, such as one or more of the storage device(s) 425. Merely by way of example, execution of the sequences of instructions contained in the working memory 435 might cause the processor(s) 410 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 400, various machine-readable media might be involved in providing instructions/code to processor(s) 410 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 425. Volatile media includes, without limitation, dynamic memory, such as the working memory 435. Transmission media includes coaxial cables, copper wire and fiber optics, including the wires that comprise the bus 405, as well as the various components of the communication subsystem 430 (and/or the media by which the communications subsystem 430 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc., carried by the signals) to the working memory 435, from which the processor(s) 405 retrieves and executes the instructions. The instructions received by the working memory 435 may optionally be stored on a storage device 425 either before or after execution by the processor(s) 410.

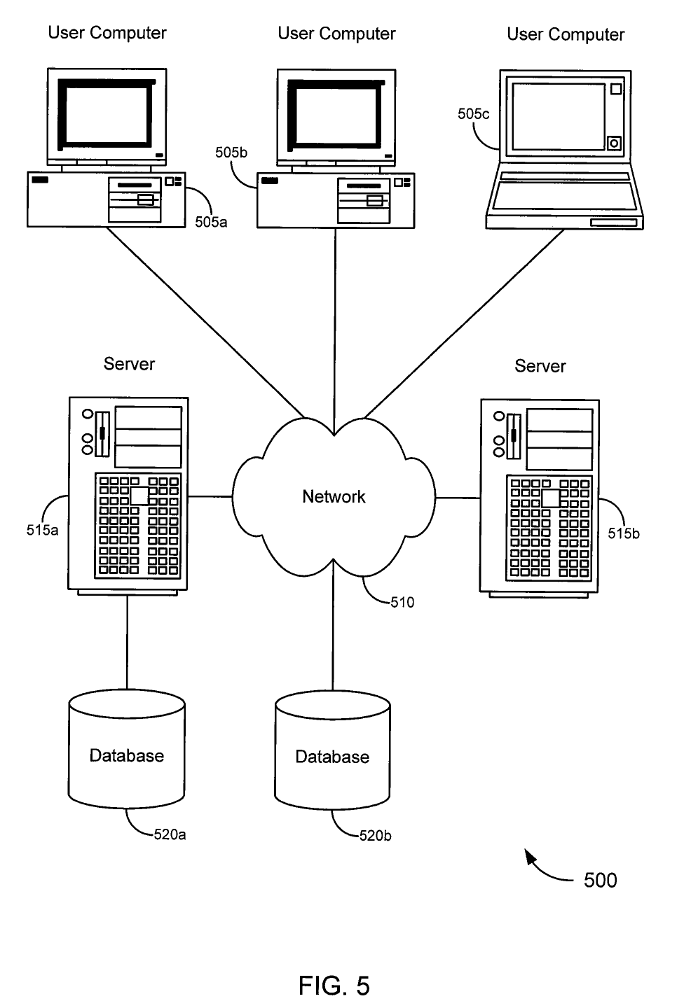

A set of embodiments comprises systems for managing an identity database and generating an identity confidence scoring system. Merely by way of example, FIG. 5 illustrates a schematic diagram of a system 500 that can be used in accordance with one set of embodiments. The system 500 can include one or more user computers 505. The user computers 505 can be general purpose personal computers (including, merely by way of example, personal computers and/or laptop computers running any appropriate flavor of Microsoft Corp.'s Windows™ (e.g., Vista™) and/or Apple Corp.'s Macintosh™ operating systems) and/or workstation computers running any of a variety of commercially-available UNIX™ or UNIX-like operating systems. These user computers 505 can also have any of a variety of applications, including one or more applications configured to perform methods of the invention, as well as one or more office applications, database client and/or server applications, and/or web browser applications. Alternatively, the user computers 505 can be any other electronic device, such as a thin-client computer, Internet-enabled mobile telephone, and/or personal digital assistant (PDA), capable of communicating via a network (e.g., the network 510 described below) and/or displaying and/or navigating web pages or other types of electronic documents. Although the exemplary system 500 is shown with three user computers 505, any number of user computers can be supported.

Certain embodiments of the invention operate in a networked environment, which can include a network 510. The network 510 can be any type of network familiar to those skilled in the art that can support data communications using any of a variety of commercially-available protocols, including without limitation TCP/IP, SNA, IPX, AppleTalk, and the like. Merely by way of example, the network 510 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 515. Each of the server computers 515 may be configured with an operating system, including without limitation any of those discussed above, as well as any commercially (or freely) available server operating systems. Each of the servers 515 may also be running one or more applications, which can be configured to provide services to one or more clients 505 and/or other servers 515.

Merely by way of example, one of the servers 515 may be a web server, which can be used, merely by way of example, to process requests for web pages or other electronic documents from user computers 505. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 505 to perform methods of the invention.

The server computers 515, in some embodiments, might include one or more application servers, which can include one or more applications accessible by a client running on one or more of the client computers 505 and/or other servers 515. Merely by way of example, the server(s) 515 can be one or more general purpose computers capable of executing programs or scripts in response to the user computers 505 and/or other servers 515, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on a user computer 505 and/or another server 515. In some embodiments, an application server can create web pages dynamically for displaying the information in accordance with embodiments of the invention, such as web interface 320 (FIG. 3). Data provided by an application server may be formatted as web pages (comprising HTML, Javascript, etc., for example) and/or may be forwarded to a user computer 505 via a web server (as described above, for example). Similarly, a web server might receive web page requests and/or input data from a user computer 505 and/or forward the web page requests and/or input data to an application server. In some cases, a web server may be integrated with an application server.

In accordance with further embodiments, one or more servers 515 can function as a file server and/or can include one or more of the files (e.g., application code, data files, etc.) necessary to implement methods of the invention incorporated by an application running on a user computer 505 and/or another server 515. Alternatively, as those skilled in the art will appreciate, a file server can include all necessary files, allowing such an application to be invoked remotely by a user computer 505 and/or server 515. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520. The location of the database(s) 520 is discretionary: merely by way of example, a database 520a might reside on a storage medium local to (and/or resident in) a server 515a (and/or a user computer 505). Alternatively, a database 520b can be remote from any or all of the computers 505, 515, so long as the database can be in communication (e.g., via the network 510) with one or more of these. In a particular set of embodiments, a database 520 can reside in a storage-area network (“SAN”) familiar to those skilled in the art. (Likewise, any necessary files for performing the functions attributed to the computers 505, 515 can be stored locally on the respective computer and/or remotely, as appropriate.) In one set of embodiments, the database 520 can be a relational database, such as an Oracle™ database, that is adapted to store, update, and retrieve data in response to SQL-formatted commands. The database might be controlled and/or maintained by a database server, as described above, for example.

In a further embodiment, a transaction system which includes a loyalty host to administer the loyalty programs may be provided. In some instances, the loyalty host may be a component of the one or more machines included in the transaction system performing other functions. Alternatively, the loyalty host may be a standalone system receiving transaction details from another component of the transaction system. The loyalty host may be used to automatically enroll customers in a loyalty program.

In one embodiment, a merchant may offer services to perform money transfer transactions. The customer may initiate a money transfer transaction by walking into a merchant location and providing details of the money transfer transaction to an agent. Money transfer transaction details may include recipient information, money transfer amount, and/or information about the customer (sender), such as a telephone number. The agent may enter the details into a POS device. When all the details have been entered, the POS device may transmit the transaction information to a transaction host for processing. Alternatively, the customer may initiate a money transfer transaction at a kiosk or other user input device.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A presentation instrument bookmark comprising:
a first panel, wherein the first panel includes an account identifying device configured to identify an account associated with the presentation instrument; and
a second panel sandwiched with the first panel, wherein the second panel includes a thumb hole cutout configured to allow the presentation instrument to be used as a bookmark.

2. The presentation instrument of claim 1, further comprising a tassel coupled to the presentation instrument.

3. The presentation instrument of claim 1, wherein the account identifying device comprises an RFID device.

4. The presentation instrument of claim 1, wherein the account identifying device comprises a magnetic stripe.

5. The presentation instrument of claim 1, further comprising a storage device embedded in the first and second panels.

6. The presentation instrument of claim 5, wherein storage device comprises one or more of the following: a secure digital (SD) memory, a micro SD memory, a mini SD memory, a flash memory, and a multimedia memory.

7. The presentation instrument of claim 6, wherein the storage device is configured to store account information.

8. The presentation instrument of claim 6, wherein the storage device is configured to store a digital book.

9. The presentation instrument of claim 1, further comprising a memory device receptacle, wherein the memory device receptacle is configured to have a memory device inserted and removed from the receptacle.

10. The presentation instrument of claim 1, wherein the thumb hole cutout is attached to the exterior of either the first panel or the second panel.

11. The presentation instrument of claim 1, further comprising a light source and battery power source coupled to the light source, wherein the light source and the battery power source are embedded within the first and second panels.

12. The presentation instrument of claim 1, further comprising a magnifying glass removably coupled with the first panel.

13. The presentation instrument of claim 1, further comprising a writing device removably coupled with the first panel.

14. The presentation instrument of claim 13, wherein the writing device comprises one or more of the following: a highlighter, a pen, a pencil, and a colored pencil.

15. The presentation instrument of claim 1, further comprising an electric contact point coupled with the first panel, wherein the electric contact point is configured to send and receive data to and from the presentation instrument.

16. The presentation instrument of claim 1, further comprising a screen coupled with the first panel, wherein the screen is configured to display electronically stored books.

17. The presentation instrument of claim 1, wherein the first and second panel together have a thickness of less than 30 mils.

18. A method of implementing a bookmark presentation instrument, the method comprising:
providing a presentation instrument, wherein the presentation instrument has an associated value;
associating an identifier with the presentation instrument, wherein the identifier is configured to identify the associated value;
attaching an account identifying device to the presentation instrument, wherein the account identifying device is configured to allow access to the associated value;
attaching a clip member to the presentation instrument, wherein the clip member is configured to allow the presentation instrument to be used as a bookmark;
placing the presentation instrument in a book to hold a place in the book; and
accessing the associated value from the presentation instrument via the account identifying device.

19. The method of claim 17, wherein the associated value comprises one or more of the following: a stored value account, a loyalty program account, a credit card account, a prepaid credit card account, and a gift card account.

20. A machine-readable medium having a set of instructions stored thereon for implementing a bookmark presentation instrument which, when executed by a machine, cause the machine to:
provide a presentation instrument, wherein the presentation instrument has an associated value;
associate an identifier with the presentation instrument, wherein the identifier is configured to identify the associated value;
attach an account identifying device to the presentation instrument, wherein the account identifying device is configured to allow access to the associated value;
attach a clip member to the presentation instrument, wherein the clip member is configured to allow the presentation instrument to be used as a bookmark;
place the presentation instrument in a book to hold a place in the book; and
access the associated value from the presentation instrument via the account identifying device.
